(19) United States
(12) Patent Application Publication
(10) Pub. No.: US 2025/0334808 A1
(43) Pub. Date: Oct. 30, 2025

(54) IMAGE ROTATION CONTROL USING REFLECTIVE WAVEGUIDE FACETS

(71) Applicant: GOOGLE LLC, Mountain View, CA (US)

(72) Inventors: Daniel Adema, Kitchener (CA); Shreyas Potnis, Kitchener (CA)

(21) Appl. No.: 18/865,081

(22) PCT Filed: Apr. 26, 2023
(86) PCT No.: PCT/US2023/019953

§ 371 Date: Nov. 12, 2024

Related U.S. Application Data
(60) Provisional application No. 63/342,710, filed on May 17, 2022.

(51) Int. Cl. G02B 27/01; G02B 6/42

(52) U.S. Cl. CPC G02B 27/0172; G02B 6/42; G02B 6/4214; G02B 2027/0123; G02B 2027/0178

(57) ABSTRACT

Techniques for implementing image rotation control using reflective waveguide facets in an AR eyewear display system are disclosed. A facet (602) is disposed in a light propagation path located between a first surface (S1) and a second surface (S2) of a waveguide (600) and is arranged to guide propagation of light for a display through the facet from the first surface to the second surface. Using this configuration, light is transmitted through the facet as it guides propagation of the light from the first surface to the second surface, which reduces the amount of image rotations or inversions that would otherwise be induced in the waveguide using conventionally oriented facets and thus simplifies or optimizes the design of other aspects of an AR eyewear display system, such as display source placement or orientation or form-factor bulkiness.

### BACKGROUND

The present disclosure relates generally to an augmented reality (AR) eyewear display. In an AR eyewear display, light from an image source is coupled into a light guide substrate, generally referred to as a waveguide, by an input optical coupling such as an in-coupling grating (i.e., an “incoupler”), which can be formed on a surface, or multiple surfaces, of the substrate or disposed within the substrate. Once the light beams have been coupled into the waveguide, the light beams are “guided” through the substrate, typically by multiple instances of total internal reflection, to then be directed out of the waveguide by an output optical coupling (i.e., an “outcoupler”), such as a reflective facet or an optical grating. The light beams projected from the waveguide overlap at an eye relief distance from the waveguide forming an exit pupil within which a virtual image generated by the image source can be viewed by the user of the eyewear display.

### SUMMARY OF EMBODIMENTS

As disclosed herein, in some embodiments a waveguide includes: a first surface; a second surface opposing the first surface; and a facet disposed in a light propagation path located between the first surface and the second surface and arranged to guide propagation of light for a display through the facet from the first surface to the second surface. In some embodiments, the facet is arranged at an oblique angle relative to a direction of propagation of light for the display at a point where the light is incident on the facet. In some embodiments, the oblique angle is less than 45 degrees. In some embodiments, the facet is a reflective waveguide facet. In some embodiments, the facet includes at least a portion of an exit pupil expander. In some embodiments, the facet is positioned such that the light for the display strikes the facet at an angle of less than about 45 degrees in at least one dimension.

In some embodiments, a waveguide includes: an incoupler; an outcoupler; and an exit pupil expander facet disposed in a light propagation path between the incoupler and the outcoupler and arranged at an oblique angle relative to a direction of propagation of light for a display at a point where the light is incident on the exit pupil expander facet. In some embodiments, the oblique angle is selected to modify an angle or an orientation of the light for the display. In some embodiments, the oblique angle is selected to compensate for an angle or an orientation of a light source relative to a desired angle or orientation of the display. In some embodiments, the exit pupil expander facet is arranged to guide propagation of the light for the display from a first surface of the waveguide to a second surface of the waveguide, wherein the first surface and second surface are opposing outer sides of the waveguide. In some embodiments, the exit pupil expander facet is a reflective waveguide facet.

In some embodiments, a method of propagating light in a waveguide includes: directing light for a display into the waveguide, wherein the waveguide includes a first surface and a second surface; and transmitting the light through a reflective waveguide facet located in the waveguide, wherein the reflective waveguide facet guides propagation of the light through the reflective waveguide facet from the first surface to the second surface. In some embodiments, the method includes directing the light into an incoupler, wherein the incoupler transmits the light toward the waveguide. In some embodiments, the method includes directing the light into an outcoupler, wherein the outcoupler transmits the light out of the waveguide. In some embodiments, the reflective waveguide facet is located along a light propagation path of the light for the display between the incoupler and the outcoupler. In some embodiments, the reflective waveguide facet is arranged at an oblique angle relative to a direction of propagation of the light for the display at a point where the light is incident on the reflective waveguide facet. In some embodiments, the oblique angle is less than 45 degrees. In some embodiments, the reflective waveguide facet includes at least a portion of an exit pupil expander. In some embodiments, the method includes directing the light into the waveguide using a display source. In some embodiments, the method includes positioning the reflective waveguide facet such that the light strikes the facet at an angle of less than about 45 degrees in at least one dimension.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a rear perspective view of an augmented reality display device implementing image rotation control using reflective waveguide facets in accordance with some embodiments.

FIG. 2 is a diagram illustrating a cross-section view of an example implementation of a waveguide in accordance with some embodiments.

FIG. 3 is a diagram illustrating basic functions of an optical combiner in accordance with some embodiments.

FIG. 4 is a diagram illustrating a waveguide with a reflective waveguide facet in accordance with some embodiments.

FIG. 5 is a diagram illustrating a conventional reflective waveguide facet.

FIG. 6 is a diagram illustrating a reflective waveguide facet implementing image rotation control in accordance with some embodiments.

FIG. 7 is a block diagram illustrating a method of implementing image rotation control using reflective waveguide facets in accordance with some embodiments.

### DETAILED DESCRIPTION

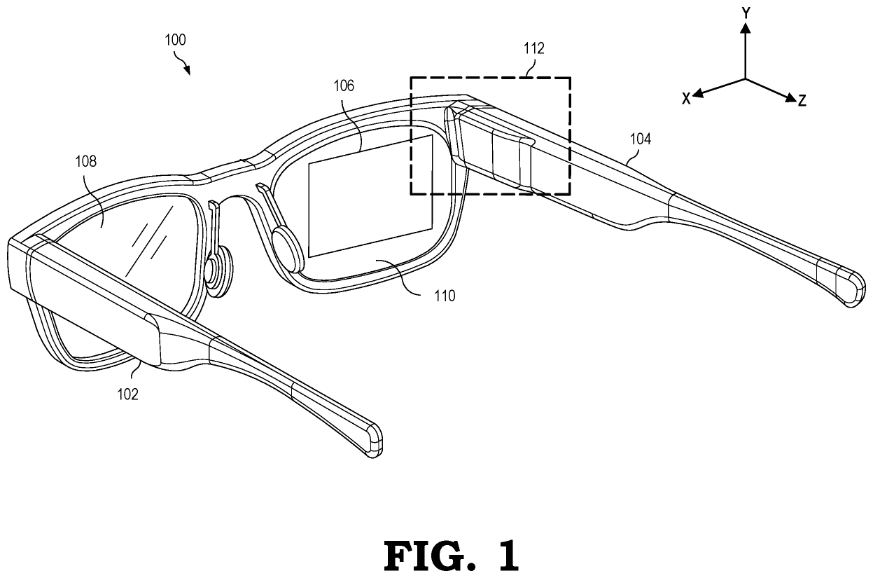

In order for a displayed image to maintain correct orientation, conventional facet-based waveguides typically require a skewed display source angle or orientation relative to a displayed image and/or other portions of a system like the AR eyewear display system 100 of FIG. 1. This is in part due to the EPE facet(s) in a plastic-molded waveguide typically reflecting light from one surface of the waveguide back to the same surface, which often results in an image inversion and/or significant image rotation. To compensate for this image inversion and/or image rotation, conventional display sources had to be rotated and/or reoriented to ensure that the displayed image maintained the correct orientation. However, such rotations and/or reorientations of the display source often imposed corresponding, undesirable design limitations, such as larger, bulkier form-factors.

FIGS. 1-7 illustrate techniques for implementing image rotation control using reflective waveguide facets in an AR eyewear display system. In some embodiments, the relative ease of designing and/or manufacturing a conventional waveguide with a conventional reflective facet is exchanged for broader design flexibility in display source placement or orientation and/or a smaller form-factor by changing the orientation of the facet and, thus, reducing the amount of image rotations or inversions that are otherwise generated by the waveguide and conventionally oriented facets. In some embodiments, a facet is disposed in a light propagation path located between a first surface and a second surface and is arranged to guide propagation of light for a display through the facet from the first surface to the second surface. In some embodiments, to enable this functionality, the facet is arranged at an oblique angle relative to a direction of propagation of light for the display at a point where the light is incident on the facet. Using this configuration, light is transmitted through the facet as it guides propagation of the light from the first surface to the second surface, which reduces the amount of image rotations or inversions that would otherwise be induced in the waveguide using conventionally oriented facets.

FIG. 1 illustrates an example AR eyewear display system 100 implementing image rotation control using reflective waveguide facets in accordance with some embodiments. The AR eyewear display system 100 includes a support structure 102 (e.g., a support frame) to mount to a head of a user and that includes an arm 104 that houses a laser projection system, micro-display (e.g., micro-light emitting diode (LED) display), or other light engine configured to project display light representative of images toward the eye of a user, such that the user perceives the projected display light as a sequence of images displayed in a field of view (FOV) area 106 at one or both of lens elements 108, 110 supported by the support structure 102. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like.

The support structure 102 further can include one or more batteries or other portable power sources for supplying power to the electrical components of the AR eyewear display system 100. In some embodiments, some or all of these components of the AR eyewear display system 100 are fully or partially contained within an inner volume of support structure 102, such as within the arm 104 in region 112 of the support structure 102. In the illustrated implementation, the AR eyewear display system 100 utilizes a spectacles or eyeglasses form factor. However, the AR eyewear display system 100 is not limited to this form factor and thus may have a different shape and appearance from the eyeglasses frame depicted in FIG. 1.

One or both of the lens elements 108, 110 are used by the AR eyewear display system 100 to provide an AR display in which rendered graphical content can be superimposed over or otherwise provided in conjunction with a real-world view as perceived by the user through the lens elements 108, 110. For example, laser light or other display light is used to form a perceptible image or series of images that are projected onto the eye of the user via one or more optical elements, including a waveguide, formed at least partially in the corresponding lens element. One or both of the lens elements 108, 110 thus includes at least a portion of a waveguide that routes display light received by an incoupler (IC) (not shown in FIG. 1) of the waveguide to an outcoupler (OC) (not shown in FIG. 1) of the waveguide, which outputs the display light toward an eye of a user of the AR eyewear display system 100. Additionally, the waveguide employs an exit pupil expander (EPE) (not shown in FIG. 1) in the light path between the IC and OC, or in combination with the OC, in order to increase the dimensions of the display exit pupil. Each of the lens elements 108, 110 is sufficiently transparent to allow a user to see through the lens elements to provide a field of view of the user's real-world environment such that the image appears superimposed over at least a portion of the real-world environment.

To allow for a smaller, more compact form-factor, in some embodiments, one or more portions of the IC, OC, and/or EPE provide image rotation control using reflective waveguide facets. Rather than configuring the reflective facets to reflect light from one surface of the waveguide back to the same surface, in order to provide better image rotation control, in some embodiments, one or more reflective waveguide facets are configured to allow light to travel through the facets from one surface of the waveguide to a different, opposing surface of the waveguide. Although in some implementations this requires a more challenging design or fabrication stage for the reflective waveguide facets, the resulting reduction in image inversion and/or image rotation enables a display source to be oriented within a system like the AR eyewear display system 100 in such a way that a smaller, more compact form-factor is achievable. For example, in some embodiments, the display source is arranged in substantially the same orientation as the displayed image. For example, in various embodiments, a difference in orientation between the image at the display source and the displayed image in one or both of the lens elements 108, 110 is up to 15 degrees, up to 10 degrees, or up to 5 degrees in any dimension. In various other embodiments, a difference in orientation between the image at the display source and the displayed image in one or both of the lens elements 108, 110 is up to 15 degrees, up to 10 degrees, or up to 5 degrees in at least one dimension or at least two dimensions.

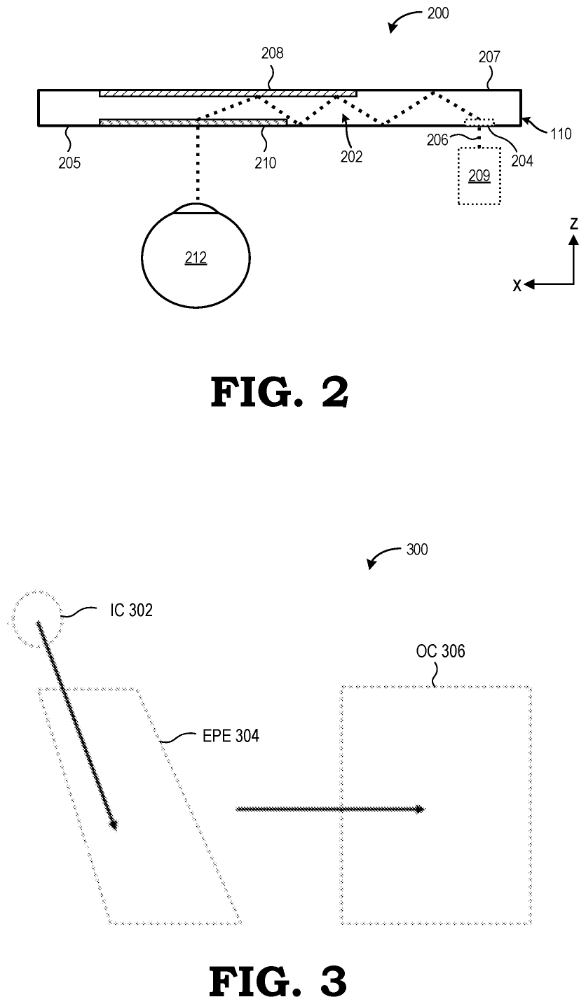

FIG. 2 depicts a cross-section view 200 of an implementation of a lens element 110 of an AR eyewear display system such as AR eyewear display system 100, which in some embodiments comprises a waveguide 202. Note that for purposes of illustration, at least some dimensions in the Z direction are exaggerated for improved visibility of the represented aspects. In this example implementation, the waveguide 202 implements facets in the region 208 on the opposite side of the waveguide 202 as the facets of the region 210, and the facets of the IC 204 are implemented on the eye-facing side 205 of the lens element 110. Likewise, the facets of region 210 (which provide OC functionality) are implemented at the eye-facing side 205. Further in this implementation, the facets of region 208 (which provide EPE functionality) is implemented at the world-facing side 207 of the lens element 110 opposite the eye-facing side 205. Thus, under this approach, display light 206 from a light source 209 is incoupled to the waveguide 202 via the IC 204, and propagated (through total internal reflection in this example) toward the region 208, whereupon the facets of the region 208 reflect the incident display light for exit pupil expansion purposes, and the resulting light is propagated to the facets of the region 210, which output the display light toward a user's eye 212. In other implementations, the regions 208 and 210 may switch sides, with the facets of region 210 formed on the world-facing side 207 and the facets of region 208 formed on the eye-facing side 205, however, this may result in the regions 208 and 210 having different positions, dimensions, and shapes, and also may require facets in each region to have different characteristics.

Whether the OC facets are disposed on the world-facing side 207 or the eye-facing side 205 of the lens element 110, embodiments achieve image rotation control using reflective waveguide facets, as described further hereinbelow. For example, in some embodiments, image rotation control using reflective waveguide facets is implemented by configuring the facets to allow light for display to travel through the facets from one surface of the waveguide to a different, opposing surface of the waveguide rather than, e.g., reflecting the light from one surface back onto the same surface. In some embodiments, as described further hereinbelow, the facets are arranged within the lens element 110 using specific angles that enable this functionality.

FIG. 3 is a diagram illustrating basic functions of an optical combiner 300 in accordance with some embodiments. A waveguide-based optical combiner (or “waveguide combiner”) is often used in AR-based near-eye displays to provide a view of the real world overlayed with static imagery or video (recorded or rendered). As illustrated in FIG. 3, such optical combiners typically employ an IC 302 to receive display light from a display source (not shown), an EPE 304 to increase the size of the display exit pupil, and an OC 306 to direct the resulting display light toward a user's eye. In some embodiments, image rotation control using reflective waveguide facets is implemented by configuring facets of the EPE to allow light for display to travel through the facets from one surface of the waveguide to a different, opposing surface of the waveguide, thus reducing image rotation and inversion, rather than, e.g., reflecting the light from one surface back onto the same surface.

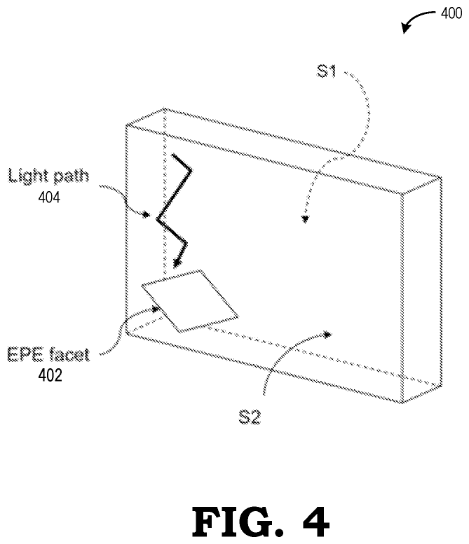

FIG. 4 is a diagram illustrating a waveguide with a reflective waveguide EPE facet 402 in accordance with some embodiments. When a waveguide combiner uses reflective facets (e.g., instead of gratings), care must be taken to ensure proper orientation or rotation of the displayed image represented by the received display light. As noted above, conventional facet-based waveguide combiners typically require a skewed display source orientation in order for the displayed image to exhibit the correct orientation. FIG. 4 depicts a plastic-molded waveguide 400 (implemented in, for example, an ophthalmic lens with an eyeglasses frame) with an EPE facet 402 arranged at an angle relative to a direction of propagation of light for the display at a point where the light is incident on the facet. In this configuration, in some embodiments, the light path causes total internal reflection (TIR) on surface S1 (the back side or eye-facing side) and surface S2 (the front side or world-facing side). In some embodiments, the EPE facet 402 implements image rotation control by arranging the EPE facet 402 at a specific angle (e.g., an oblique angle) relative to a direction of propagation of light for the display at a point where the light for the display 404 is incident on the EPE facet 402. In some embodiments, this configuration enables the EPE facet 402 to guide propagation of light for the display through the facet from the first surface (e.g., S1) to the second surface (e.g., S2), thus minimizing image rotations and inversions.

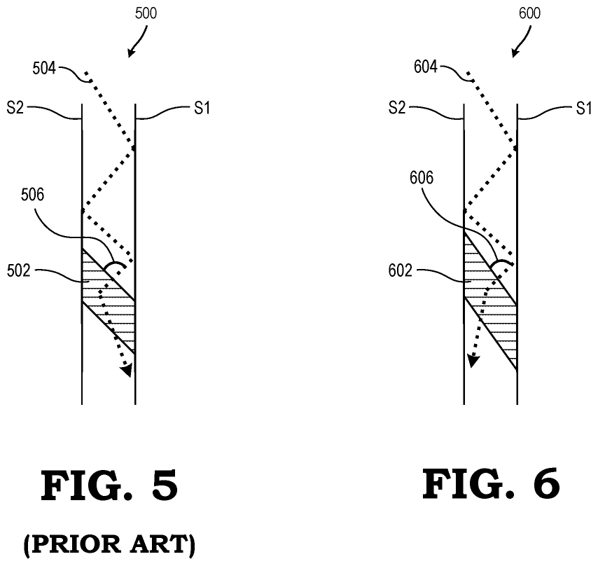

FIG. 5 is a diagram illustrating a conventional waveguide 500 with a conventional reflective EPE facet 502. In conventional approaches, orientation of EPE facets (only one EPE facet 502 is illustrated for clarity) results in a light propagation path 504 that reflects light from one surface of the waveguide 500 back to the same surface. For example, as shown in FIG. 5, the light propagation path 504 of light for display reflects off the sides S1, S2 (e.g., the outer sides) of the waveguide 500 in TIR until it is incident on the reflective EPE facet 502. The reflective EPE facet 502 then reflects the light propagation path 504 originating from surface S1 back to surface S1. However, in some embodiments, a reflective facet in a conventional waveguide reflects light from surface S2 back to surface S2.

This functionality of the conventional reflective EPE facet 502 is enabled by the conventional angle 506 of the EPE facet 502 relative to a direction of propagation of light for the display along the light propagation path 504 at a point where the light is incident on the facet. That is, by using an angle of about 45-60 degrees for the conventional angle 506 (and thus an angle of incidence of 30-45 degrees), the conventional reflective EPE facet 502 is relatively easy to design and manufacture and results in a reflection of the light for display from one surface (e.g., surface S1) of the waveguide 500 back to the same surface of the waveguide 500. However, using such a conventional angle 506 and reflecting the light for display from a first surface back onto itself typically results in undesirable additional image rotations and/or inversions, as discussed above, which can complicate other aspects of a system like AR eyewear display system 100, such as placement or orientation of a display source and/or the bulkiness of portions of the form-factor. As described herein, in some embodiments, the relative ease of designing and/or manufacturing a conventional waveguide 500 with a conventional reflective EPE facet 502 is exchanged for broader design flexibility in display source placement or orientation and/or a smaller form-factor by changing the orientation of the EPE facet 502 and, thus, reducing the amount of image rotations or inversions that are otherwise generated by the waveguide 500 and conventional facets like conventional reflective EPE facet 502.

FIG. 6 is a diagram illustrating a reflective waveguide facet implementing image rotation control in accordance with some embodiments. In some embodiments, a novel orientation of EPE facets (only one EPE facet 602 is illustrated for clarity) results in a light propagation path 604 that enables light to pass from one surface (e.g., surface S1) of a waveguide 600 to another, typically opposing surface (e.g., surface S2) of the waveguide 600, thus reducing the amount of image rotations or inversions that are otherwise generated by conventional facets like conventional reflective EPE facet 502. This functionality of the EPE facet 602 is enabled by the novel angle 606 of the EPE facet 602 relative to a direction of propagation of light for the display along the light propagation path 604 at a point where the light is incident on the facet. That is, by using an angle of about 20-45 degrees (e.g., greater than about 20 degrees or less than about 45 degrees) for the angle 606 in at least one dimension (and thus an angle of incidence of 45-70 degrees, greater than about 45 degrees, or less than about 70 degrees), such that the light strikes the facet at angle 606, the reflective EPE facet 602 induces a transmittal of the light for display from one surface (e.g., surface S1) of the waveguide 600 to another surface of the waveguide 600, although such a configuration is typically relatively more difficult to design and manufacture than a conventional reflective EPE facet 502.

Using such an angle 606 and enabling the light for display to pass from a first surface (e.g., surface S1 or surface S2), through the EPE facet 602, to a second surface (e.g., surface S2 or surface S2) limits the number of image rotations and/or inversions induced by the waveguide 600, as discussed above, which allowed for broader design flexibility of other aspects of a system like AR eyewear display system 100, such as placement or orientation of a display source and/or reducing the bulkiness of portions of the form-factor. In some embodiments, a particular angle, such as an oblique angle, is selected for the angle 606 in order to modify an angle or an orientation of the light for the display, for example to compensate for an angle or an orientation of a light source relative to a desired angle or orientation of the display. For example, in some embodiments, when a display source and/or one or more components in the waveguide 600 induce a particular amount of image rotation, the angle 606 is selected to at least partially offset that rotation by modifying the angle or orientation of the light for the display through the resulting orientation of the EPE facet 602.

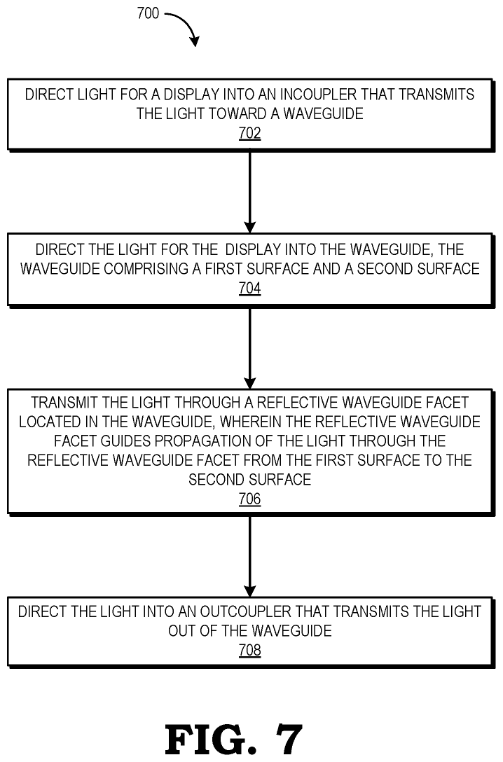

FIG. 7 is a block diagram illustrating a method 700 of implementing image rotation control using reflective waveguide facets in accordance with some embodiments. At block 702, a display source, such as light source 209 of FIG. 2, directs light for display into an IC, such as IC 204, which transmits the light toward a waveguide, such as waveguide 202 of FIG. 2 or waveguide 600 of FIG. 6.

At block 704, an IC, such as IC 204, directs light for the display into a waveguide, such as waveguide 202 of FIG. 2 or waveguide 600 of FIG. 6, the waveguide having a first surface and a second surface, such as surfaces S1, S2 of FIG. 6. At block 706, the waveguide transmits the light for display through a reflective waveguide facet, such as the EPE facet 602 of FIG. 6, which guides propagation of the light for the display from the first surface (e.g., surface S1 or surface S2 of FIG. 6) to the second surface (e.g., surface S2 or surface S1 of FIG. 6, respectively). At block 708, the waveguide directs the light for the display into an OC, such as OC 306 of FIG. 3, at which time the OC transmits the light for the display out of the waveguide and, e.g., toward a user's eye to provide the intended display.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A waveguide comprising:
a first surface;
a second surface opposing the first surface; and
a facet disposed in a light propagation path located between the first surface and the second surface and arranged to guide propagation of light for a display through the facet from the first surface to the second surface.

2. The waveguide of claim 1, wherein the facet is arranged at an oblique angle relative to a direction of propagation of light for the display at a point where the light is incident on the facet.

3. The waveguide of claim 2, wherein the oblique angle is less than 45 degrees.

4. The waveguide of claim 1, wherein the facet is a reflective waveguide facet.

5. The waveguide of claim 1, wherein the facet comprises at least a portion of an exit pupil expander.

6. The waveguide of claim 1, wherein the facet is positioned such that the light for the display strikes the facet at an angle of less than about 45 degrees in at least one dimension.

7. A waveguide comprising:
an incoupler;
an outcoupler; and
an exit pupil expander facet disposed in a light propagation path between the incoupler and the outcoupler and arranged at an oblique angle relative to a direction of propagation of light for a display at a point where the light is incident on the exit pupil expander facet.

8. The waveguide of claim 7, wherein the oblique angle is selected to modify an angle or an orientation of the light for the display.

9. The waveguide of claim 7, wherein the oblique angle is selected to compensate for an angle or an orientation of a light source relative to a desired angle or orientation of the display.

10. The waveguide of claim 7, wherein the exit pupil expander facet is arranged to guide propagation of the light for the display from a first surface of the waveguide to a second surface of the waveguide, wherein the first surface and second surface are opposing outer sides of the waveguide.

11. The waveguide of claim 7, wherein the exit pupil expander facet is a reflective waveguide facet.

12. A method of propagating light in a waveguide, comprising:
directing light for a display into the waveguide, wherein the waveguide comprises a first surface and a second surface; and
transmitting the light through a reflective waveguide facet located in the waveguide, wherein the reflective waveguide facet guides propagation of the light through the reflective waveguide facet from the first surface to the second surface.

13. The method of claim 12, further comprising directing the light into an incoupler, wherein the incoupler transmits the light toward the waveguide.

14. The method of claim 13, further comprising directing the light into an outcoupler, wherein the outcoupler transmits the light out of the waveguide.

15. The method of claim 14, wherein the reflective waveguide facet is located along a light propagation path of the light for the display between the incoupler and the outcoupler.

16. The method of claim 12, wherein the reflective waveguide facet is arranged at an oblique angle relative to a direction of propagation of the light for the display at a point where the light is incident on the reflective waveguide facet.

17. The method of claim 16, wherein the oblique angle is less than 45 degrees.

18. The method of claim 12, wherein the reflective waveguide facet comprises at least a portion of an exit pupil expander.

19. The method of claim 12, further comprising directing the light into the waveguide using a display source.

20. The method of claim 12, further comprising positioning the reflective waveguide facet such that the light strikes the facet at an angle of less than about 45 degrees in at least one dimension.
